(19) United States
(12) Patent Application Publication
(10) Pub. No.: US 2016/0259136 A1
(43) Pub. Date: Sep. 8, 2016

(54) High Density Multi-Fiber Bundle and Method of Alignment for Fiber Optic Interconnection Applications

(71) Applicants: Michel Yvon Rondeau, San Francisco, CA (US); Richard F.M. Lam, San Francisco, CA (US)

(72) Inventors: Michel Yvon Rondeau, San Francisco, CA (US); Richard F.M. Lam, San Francisco, CA (US)

(21) Appl. No.: 13/838,696

(22) Filed: Mar. 15, 2013

(51) Int. Cl. G02B 6/40; G02B 6/38

(52) U.S. Cl. CPC G02B 6/403; G02B 6/3885; G02B 6/3834; G02B 6/3863

(57) ABSTRACT

A new fiber optic bundle with new features, designs and manufacturing processes, specifically related to the configurations and the special manufacturing methods of High Density Multi-fiber Bundles for fiber optic interconnection applications has been developed for 19 fibers and 37 fibers. Fiber bundles greater than 37 fibers are also included.

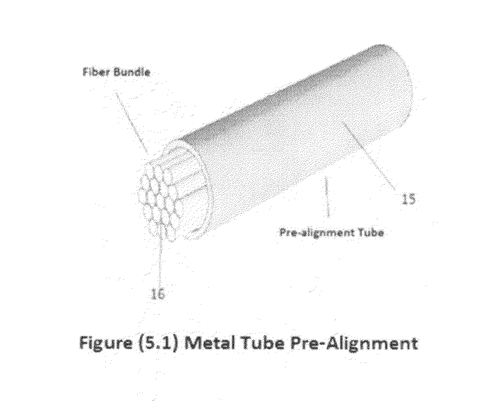

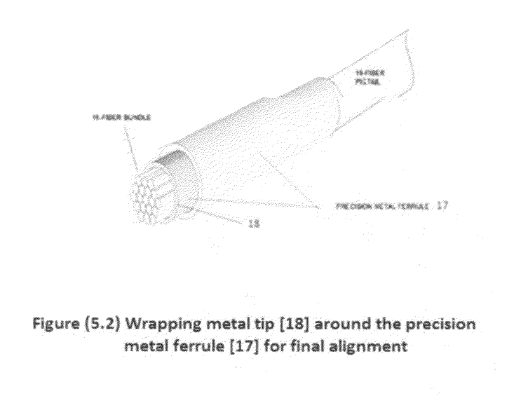

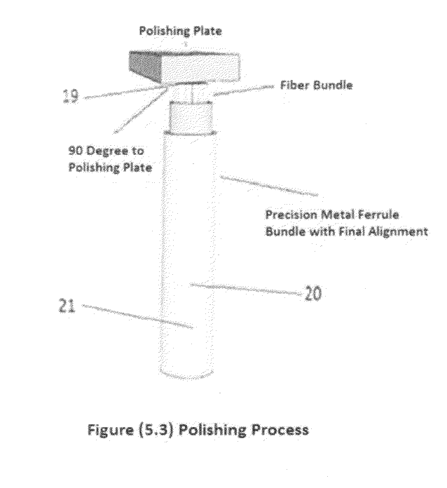

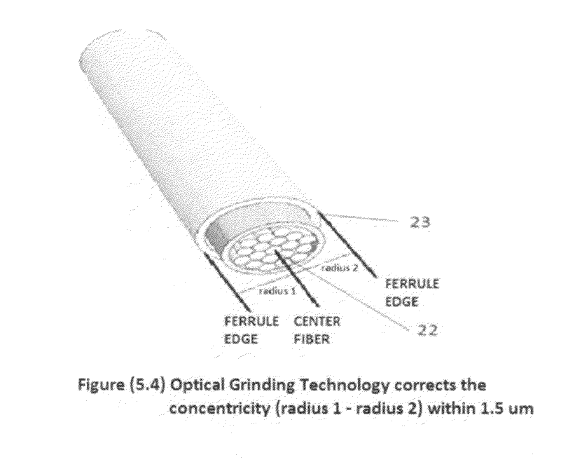

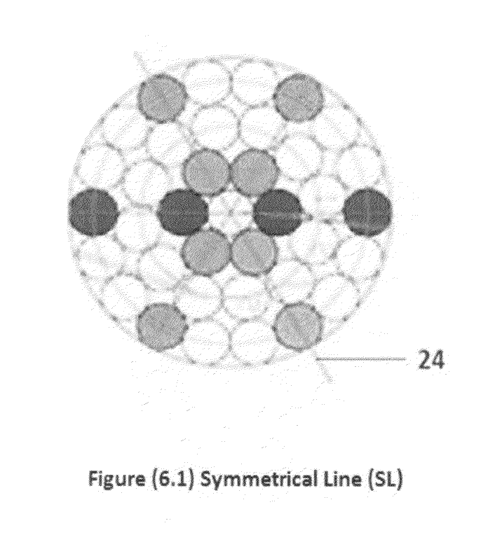

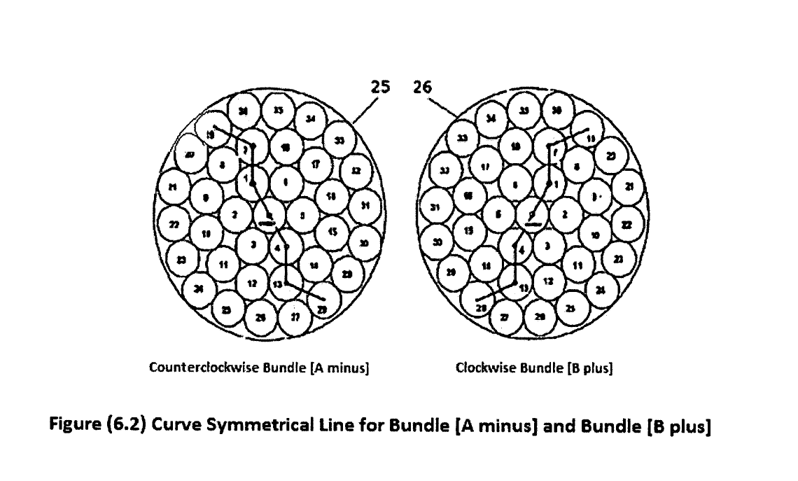

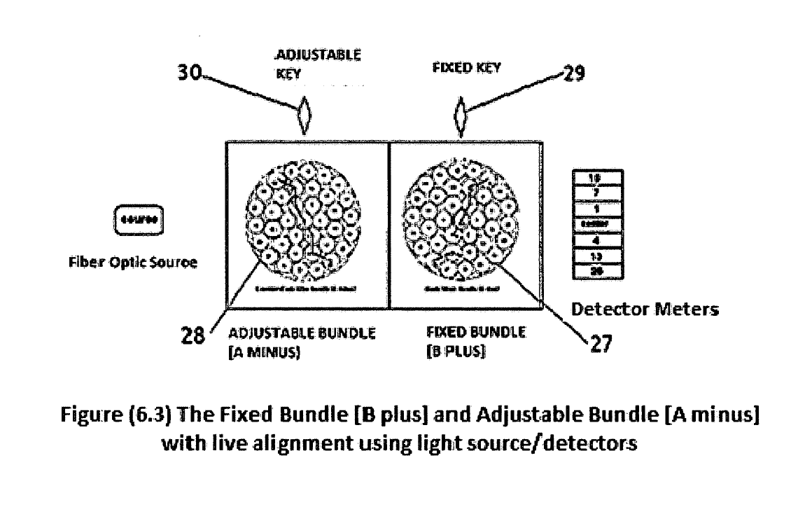

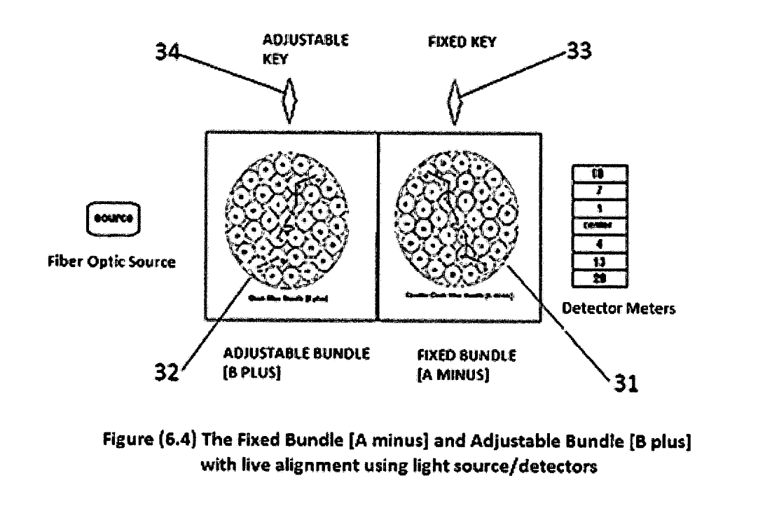

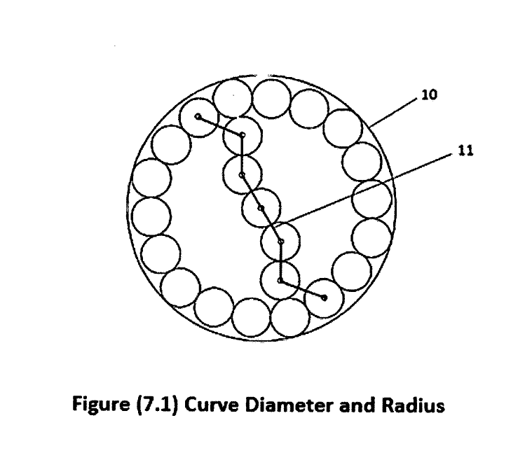

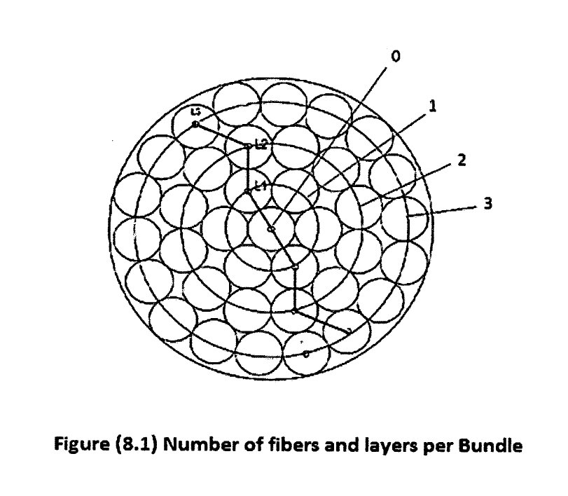

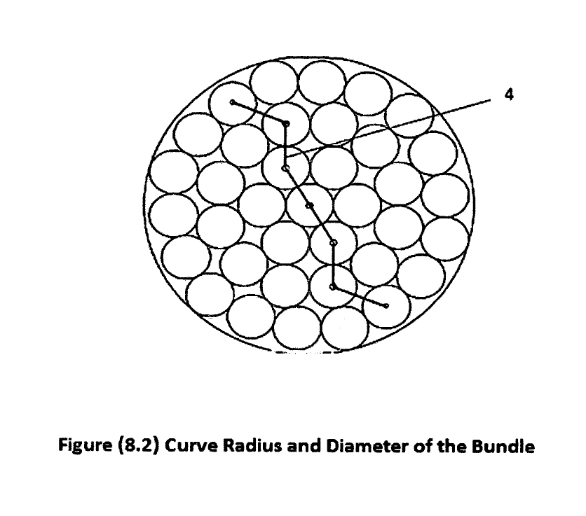

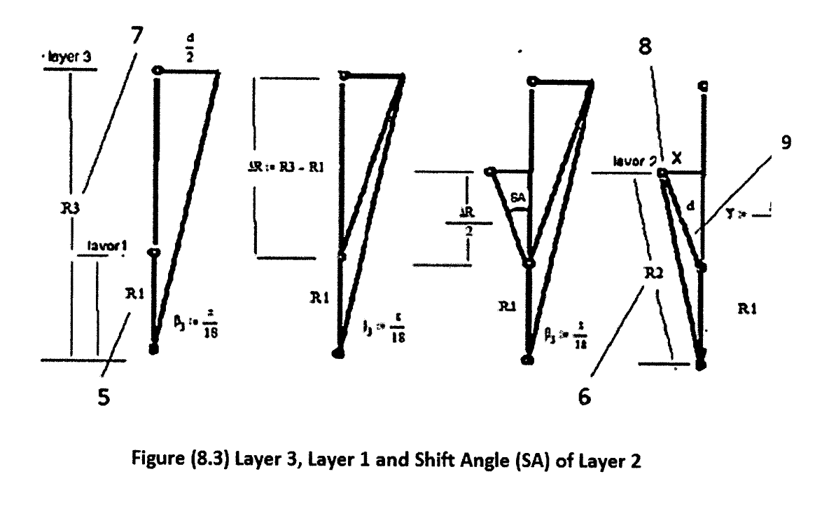

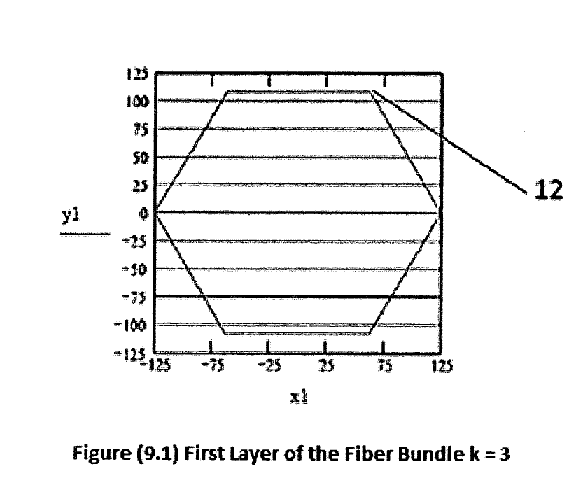

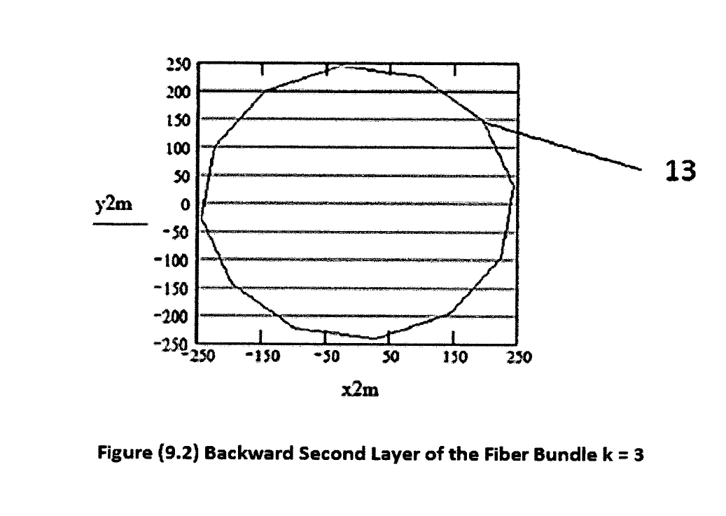

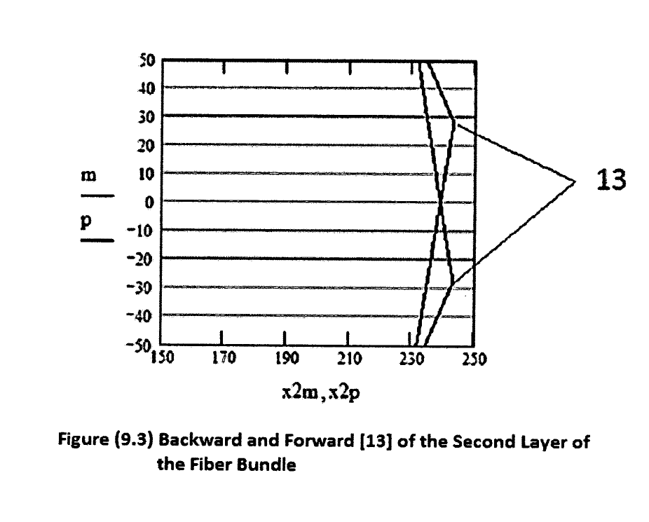

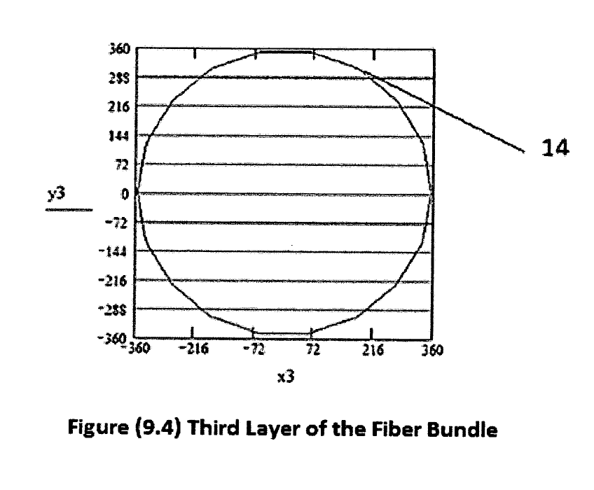

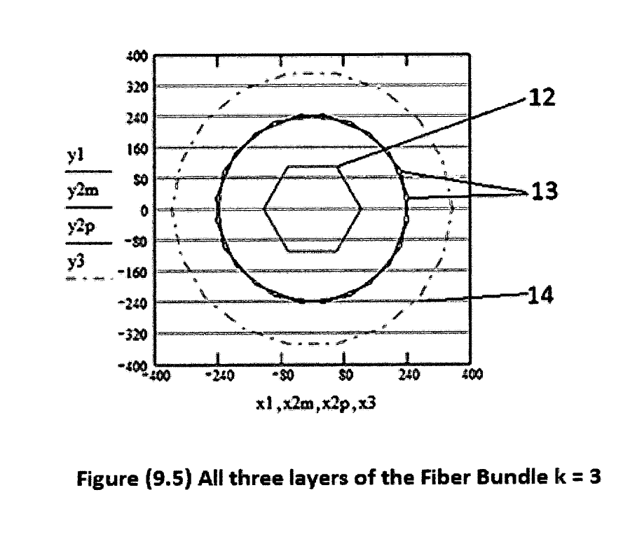

The Bundle [A] and Bundle [B] Pigtails for multi-fiber connectors or device applications are used in pairs. The 19 or 37-fiber Bundle Pigtail Pairs are concentric to the outside diameter of a metal ferule. The individual fibers in the Pigtails are numbered according to the fiber orientation.

The orientation of the fibers in Bundle [A] must be clockwise and the orientation of the fibers in Bundle [B] must be counterclockwise.

For device application such as fiber optics splitters, MEMs, and optical switches, a single bundle is aligned and attached to the chip.

This application claims priority to our co-pending U.S. non-provisional patent application Ser. No. 13/838,696, esp:15260921, filed on Mar. 15, 2013, which is incorporated by reference herein.

### FIELD OF INVENTION

The field of invention is for a new fiber optic bundle with new features, designs and manufacturing processes, specifically related to the configurations and the special manufacturing methods of High Density Multi-fiber Bundles for fiber optic interconnection applications.

### BACKGROUND OF THE INVENTION

The original patent for “Metal Core Fiber optic Connector Plug for Single and Multiple Fiber Coupling”, issued in 1993 (U.S. Pat. No. 5,216,735), describes the dynamic metal wrapping of the ferrule tip. It maintains the concentricity of a single fiber to the outside is diameter of a ferrule. At present, this patent has expired.

The patent for “Connector for Impact Mounted Bundle Optical Fiber Devices”, issued in 2006 (Patent US#5363-301601), is limited to seven fibers (Heptoport®). This patent uses the original patent above (U.S. Pat. No. 5,216,735). Additional claim included in this patent is the alignment of the outside six (6) fibers with a key on the ferrule. There are a total of seven fibers. The wrapping process reduces the 7-fiber bundle geometry to a minimum. The alignment of a bundle is achieved by using a Straight Symmetrical Line and a keyed ferrule only. This 7-fiber bundle is used for illumination.

The new invention described in this document, “High Density Multi-Fiber Bundle and Method of Alignment for Fiber Optic Interconnection Applications” increases the number of fibers greater than seven (19, 37 . . . ). For fibers (19, 37 . . . ), the EVEN layers in the bundle are shifted by a Shift Angle (SA) relative to the ODD layers. The ODD layers do not shift and are in line to each other. To achieve a good connection between bundle/bundle or bundle/device, it requires a Curve Symmetrical Line with a Shift Angle and also a keyed ferrule.

The manufacturing processes are also unique to the High Density Multi-Fiber Bundle. To achieve a minimum geometry for fibers in a bundle, the pre-alignment metal tube and the gradual wrapping of the metal around the ferrule tip in multiple increments allow the shifting of the EVEN layers to their final positions.

Various objects, features, aspects and advantages of the present invention will become more apparent from the following detailed description of preferred embodiments of the invention.

### SUMMARY OF THE INVENTION

A fiber optic bundle with 19 or 37 fibers are designed and manufactured as Pigtails for multi-fiber connector or device applications. The 19 or 37-fiber bundles are concentric to the outside diameter of a metal ferule. The individual fibers in the Pigtails are numbered according to the fiber orientation in the fiber bundles where the fiber bundle can be made within a precision ferrule with a diameter from 1.0 mm to 5.0 mm. This is ideal for high density and limited space applications. Fiber bundles greater than 37 fibers are also included.

The FOUR main methods to achieve multi-fiber alignment are:
1) Dynamically wrapping metal ferrule tip to obtain minimum shape and volume and matching of the Curve Symmetrical Lines of Bundle [A] and Bundle [B]. See FIG. (6.3).
2) Alignment of Precision Ferrule Keys in Bundle [A] and Bundle [B] for connector applications.
3) Identification of the Shift Angle orientation for the EVEN layers in the bundle.
4) For connector applications, a key in each fiber bundle is used to align the fibers of the bundle. To achieve a complete connection between Bundle [A] and Bundle [B], the orientation of the fibers in Bundle [A] must be clockwise and the orientation of the fibers in Bundle [B] must be counterclockwise. For device applications such as fiber optic splitters, MEMs, and optical switches, a single bundle is aligned and attached to the chip as shown in the following figures.

### BRIEF DESCRIPTION OF THE DRAWING

FIG. (5.1) is a schematic diagram of the metal tube pre-alignment, according to the inventive subject matter.

FIG. (5.2) is a schematic diagram of wrapping metal around bundle for final alignment, according to the inventive subject matter.

FIG. (5.3) is a schematic diagram of the polishing process, according to the inventive subject matter.

FIG. (5.4) is a schematic diagram of the Optical Grinding Technology corrects the concentricity (radius 1−radius 2) within 1.5 urn, according to the inventive subject matter.

FIG. (6.1) is a schematic diagram of the Symmetrical Line (SL), according to the inventive subject matter.

FIG. (6.2) is a schematic diagram of the Curve Symmetrical line for Bundle (A minus) and Bundle (B plus) process, according to the inventive subject matter.

FIG. (6.3) is a schematic diagram of the fixed Bundle (B plus) and adjustable Bundle (A minus) with live alignment using light source/detectors, according to the inventive subject matter.

FIG. (6.4) is a schematic diagram of the fixed Bundle (A minus) and adjustable Bundle (B plus) with live alignment using light source/detectors, according to the inventive subject matter.

FIG. (7.1) is a schematic diagram of the Curve Radius and Diameter, according to the inventive subject matter.

FIG. (8.1) is a schematic diagram of the number of fibers and layers per bundle, according to the inventive subject matter.

FIG. (8.2) is a schematic diagram of the Curve Radius and Diameter for a 19-fiber bundle, according to the inventive subject matter.

FIG. (8.3) is a schematic diagram of Layer 3, Layer 1 and Shift Angle (SA) of Layer 2, according to the inventive subject matter.

FIG. (9.1) is a schematic diagram of the first layer of fiber bundle k=3, according to the inventive subject matter.

FIG. (9.2) is a schematic diagram of the backward second layer of fiber bundle k=3, according to the inventive subject matter.

FIG. (9.3) is a schematic diagram of the backward and forward (13) of second layer of bundle.

FIG. (9.4) is a schematic diagram of the third layer of the bundle, according to the inventive subject matter.

FIG. (9.5) is a schematic diagram of all three layers of the bundle (k=3), according to the inventive subject matter.

### DETAILED DESCRIPTION

### Bundle Manufacturing Processes are Described in the Following with Associated Figures and Equations for the Methods

The first process in making the fiber bundle is to keep the center fiber concentric to the metal ferrule O.D by minimizing the fiber bundle to its smallest area. There are three stages:

Stage one is to pre-align the fibers in a metal tube with diameter defined below:

TDₖ=(2*k+1)*d, where k is the number of layer and d is the diameter of the fiber. See FIG. (5.1) for detail.

For k=2, we have TD=5*d. All fibers in the bundle are also stretched to help placing the fibers in the gap.

Stage two of the process involves sliding the metal tube [15] with the fiber bundle [16] in place inside the Precision Metal Ferrule (PMF) [17]. The tip [18] of the PMF is deformed around all 19 fibers using at first small wrapping force to align all fibers of each sub-layer into the internal gap. Then, the wrapping force is increased in multiple increments to reach the minimum area. The minimum area will align the nodes in the fiber bundle within submicrons. See FIG. (5.2) for detail.

Stage three involves polishing the fiber bundle at 90 degree [19] from the PMF axis. This will guarantee full contact between bundle [20] or device [21]. See FIG. (5.3) for detail.

The second process requires a proprietary Optical Grinding Technology (OGT) to correct the concentricity of the metal ferrule O.D. with the center fiber [22] within 1.5 μm. See FIG. (5.4) for detail.

For the third process, the Bundle Curve Symmetrical Line and Key Alignment are performed in the following inventive steps below:

To achieve the alignment, the Curve Symmetrical Line (CSL) [4] and the fiber orientation for Bundle [A minus] [25] and Bundle [B plus] [26] must be setup properly. All fibers on the Curve Symmetrical Line [4] of Bundle [A minus] [25] are designated as the starting fiber for each layer in a counter-clockwise (left) direction. In this case, all fibers on the Curve Symmetrical Line of Bundle [B plus] [26] are designated as the starting fiber for each layer in a clockwise (right) direction. See FIG. (6.2) for detail.

To obtain minimum transmission loss (dB) of less than 0.5 dB per fiber connection between Bundle [A minus] and Bundle [B plus], it requires the Curve Symmetrical Line (CSL) of Bundle [A minus] to shift counterclockwise (left) and the Curve Symmetrical Line for Bundle [B plus] to shift clockwise (right) relative to the straight Symmetrical Line (SL) [22]. The amount of shifting of the Curve Symmetrical Lines is defined by the Shift Angle. See FIG. (6.1) and FIG. (6.2) for detail.

Finally the key on each ferrule are aligned using fixtures as follows: to make the Bundle [A] [28], it requires a Master Bundle Fixture [B] [27] that has a fixed key [29]. The adjustable key [30] of Bundle [A] [28] is used to align the Curve Symmetrical Line with the fixed Master Bundle Fixture [B]'s key [30] of the opposite side. The key is then permanently mounted in place.

Similarly, to make Bundle [B] [32], it requires a Master Bundle Fixture [A] [31] that has a fixed key [33]. The adjustable key [34] of Bundles [B] [32] is used to align the Curve Symmetrical Line with the fixed Master Bundle Fixture [A]'s key [33] of the opposite side. The key is then permanently mounted in place.

For the Bundle Curve Diameter and Radius Configuration, they Must be Done in the Following Methods:

The Bundle Parameter (BP) [10] and the Curve Diameter (CD) [11] are defined below:

BPₖ=6*k*, for k layers and fiber diameter “d” Eq. 7.0

Similarly, the Bundle Parameter (BP) can also be written using the Curve Diameter (CD) as shown here:

BPₖ=π*cd for k layer sand Curve Diameter (CD) Eq. 7.1

If we combine Equation (7.0) and Equation (7.1) and solve for the Curve Diameter, we obtain:

CD=6*k*d/π, Curve Diameter for layer “k” Eq. 7.2.

See following FIG. (7.1) for detail.
For k=3, Equation (7.2) gives us:

d=125,

CD:=18−d/π

CD=716.197

or using Equation (8.8), we get

R3:=354.56

where CD:=R3−2, CD=709.12

The Bundle Straight Diameter (SD) [24] can be calculated by using Equation (8.4) for the diameter of the fiber as shown below:

SD=(2*k+1) Eq. 7.3 where “k” is the number of layers.

Next, we define the Ratio between Equation (7.2) and Equation (7.3) as follows

Ratio=6*k/(2*k+1) Eq. 7.4

Then, if we take the limit of Ratio as (k) goes to infinity, we will have the equation as shown below:

go to Ratio=0.96 which is <1 Eq. 7.5.

Because the ratio is Ratio <1, this will imply that all fibers are in contact for any layers.

Multi-Fiber Bundle and Shift Angle Equations are Configured as Follows in Respect to this Innovation that Covers Fiber Optic Bundles with the Number of Fibers Per Bundle as Follows:

k:=4 n:=0, 1 . . . k−1, where k is the number of layers

FNₙ: =3*n*(n+1)+1, where

n=0 gives “1” fiber bundle,

n=1 gives “7” fiber bundle,

n=2 gives “19” fiber, and

n=3 gives “37” fiber bundle Eq. 8 for

$$FN = [ \begin{matrix}1 \\ 7 \\ 19 \\ 37\end{matrix} ]$$

This is the equation for the number of fibers in a bundle, and “k’ is the number of layers in the bundle:

The number of fibers per k-layer [0], [1], [2], [3] is given by: Where k:=0, 1, . . . 3,

Lₖ=6*k,

L₀: =1,

where k=0, or k=1, or k=2, k=3 for

$$L = [ \begin{matrix}1 \\ 6 \\ 12 \\ 18\end{matrix} ]$$

Where, n=3 and the fiber number is

“37” Eq. 8.1.

See FIG. (8.1) for more detail.

The number of fibers for the Curve Diameter (CD) [4] is as follows:

CDₙ: =(2−n+1) Eq. 8.3

The Curve Radius (CR) is as follows:

CRₙ=(n+½) Eq. 8.4

See FIG. (8.2) for more detail.

The Angle (AL) and Radius (RL) of each layer (L) in the bundle will be defined below. The Radius (r) and the Diameter (d) of the fiber are the standard parameters used in the industry.

R: =62.5 μm Radius Eq. 8.5

d: =125 μm Diameter

where the angle (AL) in each layer is based on the number of fibers in the layer. See Equation (8.1).

ALₙ: =n+1

ALₙ:=180/(3−(n+1)) Eq. 8.6

where n=1 gives “60” per fiber,

n=2 gives “30” per fiber,

n=3 gives “20” per fiber

$$AL = [ \begin{matrix}60 \\ 30 \\ 20 \\ 15\end{matrix} ]$$

The Radius of each layer [5], [6], [7] is defined

R3=d/((2−tan(π/18))

R1:=d

R2:(R1−(R3)+(R1))^{0.5} Eq. 8.7

R1=125

R2=244.81 Eq. 8.8

R3=354.455

See FIG. (8.2) for more details.

All Even Numbered Layers of the Bundles are Shifted Relative to the Odd Numbered Layers [8] of the Bundles. The Shift Angle [9] for the First Even Numbered Layer (Layer 2) is Calculated as Follows:

ΔR: =(R3−R1)/2,

where ΔR=114.72 Eq. 8.9

SA: =a cos(ΔR/d), where SA=23.391*deg.

See FIG. (8.3) for more details.

The Fiber Nodes in a Bundle are Configured as Follows:

The number of nodes in each layer (which are the centers of each fiber) is defined by Equation (2.3). The Symmetrical Line is defined as a straight line through the center fiber and is also going through all ODD layers. The EVEN layers are shifted away from the Symmetrical Line. The Shift Angle (SAp, SAm) of the EVEN layers are either shifting clockwise to the right or counterclockwise to the left of the Symmetrical Line. All the nodes in the bundle are calculated as below:

The coordinates (X1, Y1) are the nodes in Layer 1 and Radius R1 [12] Where i:=0, 1 . . . 6

X1ᵢ=R1−cos((i−π)/3) Eq.9.1

Y1ᵢ=R1−sin((i−π/3).

See FIG. (9.1) for detail.

The coordinates (X2′, Y2) are the nodes in Layer 2 with radius R2. [13] where the Shift Angle in Equation (8.9) goes backward as follows:

SAminus:=a cos(ΔR/d) Eq. 9.2

### Where j:=0, 1 . . . 12,

X2mⱼ:=R2−cos((j−π/6−SAminus) Eq.9.3

Y2mⱼ:=R2−sin((j−π)/6−SAminus)

See FIG. (9.2) for detail.

The coordinates (X2′, Y2) are the nodes in Layer 2 with radius R2 where the Shift Angle in equation (8.9) goes forward as follows:

SAplus:=a cos(ΔR/d) Eq. 9.4,

### Where j:=0, 1 . . . 12,

X2pⱼ:=R2−cos((j−π)/6−SAplus) Eq.9.5

Y2pⱼ:=R2−sin((j−π)/6−SAplus)

See FIG. (9.3) for detail.

The coordinates (X3′, Y3) are the nodes in Layer 3 and Radius R3 [14] where the Shift Angle in Equation (8.9) is as follows:

### Where m:=0, 1 . . . 18

X3ₘ:=R3−cos((m−π/9) Eq.9.6

Y3ₘ:=R3−sin((m−π)/9)

See FIG. (9.4) for detail.

The graphic representation are as follow:

Coords_{i,0}:=X1ᵢ, Coords_{i,1}:=Y1ᵢ

x1:=Coords^{<0>}, y1:=Coords^{<0>}

Coords_{j,0}: =X2mᵢ, Coords_{j,0}:=Y2mᵢ

x2m:=Coords^{<1>}, y2m:=Coords^{<1>},

Coords_{j,0}:=(X2p)ⱼ, Coords_{j,1}:=Y2pⱼ,

X2p:=Coords^{<0>}, y2p:=Coords^{<1>},

Coords_{m,0}: =X3ₘ, Coords m,₁:=Y3ₘ

X3:=Coords^{<0>}, Y3:=Coords^{<1>},

FIG. (9.5) shows a combination of all the layers in a bundle defined by the above FIGS. (9.1) to (9.4).

### GLOSSARY

| | | |
|---|---|---|
| 1. | (k) | Number of layers in a bundle |
| 2. | (d) | Diameter of fiber |
| 3. | (r) | Radius of fiber |
| 4. | (X, Y) | Node Coordinates |
| 5. | CDn | Number of fibers in Curve Diameter |
| 6. | CRn | Number of fibers in Curve Radius |
| 7. | Fn | Number of fibers in a bundle |
| 8. | Ln | Number of fibers in each layer |
| 9. | (An) | Angle of each layer |
| 10. | (BP) | Bundle Parameter |
| 11. | (CA) | Curve Angle |
| 12. | (CD) | Curve Diameter |
| 13. | (CR) | Curve Radius |
| 14. | (CSL) | Curve Symmetrical Line |
| 15. | (Nodes) | Fiber Core |
| 16. | (Rn) | Layer Radius |
| 17. | Ratio | Parameter Ratio |
| 18. | (PMF) | Precision Metal Ferrule |
| 19. | (SA) | Shift Angle |
| 20. | (SD) | Straight Diameter |
| 21. | (SL) | Symmetrical Line |
| 22. | (TD) | Tube Diameter |

What is claimed:

1. The layers in each bundle are divided in ODD and EVEN where the EVEN layers are shifted by the Shift Angle (SA). (See Equation 8.9 and FIG. (8.1). The ODD layers DO NOT shift.

2. The EVEN layers in the bundle will be shifted either to clockwise (right) or counterclockwise (left) of the ODD layers. See FIG. (6.3).

3. The method of claim 1 further comprising all bundles are aligned in a circular mode controlled by a pre-alignment metal tube that maintains the circular shape. See FIG. (5.1).

4. The method of claim 1 further comprising the circular pre-alignment metal tube guarantees the correct geometry needed for the final alignment.

5. The method of claim 1 further comprising the multi-fiber metal ferrule tip deformation has to be performed in multiple stages to guarantee the proper Shift Angle of the EVEN layers of the fiber bundle.

6. The method of claim 2 further comprising The four main methods to achieve multi-fiber alignment are:
a) Dynamically wrapping metal ferrule tip to obtain minimum shape and volume.
b) Matching of the Curve Symmetrical Lines of Bundle [A] and Bundle [B]. See FIG. (6.3).
c) Alignment of Precision Ferrule Keys in Bundle [A] and Bundle [B] for connector application. See FIG. (6.3).
d) Identification of the Shift Angle orientation for the EVEN layers in the bundle.

7. The method of claim 2 further comprising The Shift Angle (SA) gets smaller with larger bundles. See Equation (8.9).

8. The method of claim 2 further comprising Connector applications require two precision ferrule bundles, each with an alignment key.

9. The method of claim 8 further comprising For connector applications, a key on each fiber bundle is used to align the fibers of the bundle. To achieve a complete connection between Bundle [A] and Bundle [B], the orientation of the fibers in Bundle [A] must be clockwise and the orientation of the fibers in Bundle [B] must be counterclockwise.

10. The method of claim 9 further comprising To manufacture Bundle [A] and Bundle [B], it needs to setup a master bundle for each of the bundle in the opposite side. See FIG. (6.3) and FIG. (6.4).

12. The method of claim 1 further comprising The equation for the number of fibers per bundle is: 3*n*(n+1) for n>1 (See equation 8.0). As an example, where n=2, the total number of fibers in the bundle will be 19.

13. The method of claim 6 further comprising The equation for the number of fibers per layer is: 6*k for k>1 (See Equation 8.1).
As an example, where k=2, the 2nd layer will have 12 fibers. The number of layers per bundle is “n”.

14. The method of claim 6 further comprising To achieve a minimum geometry for the fibers in the bundle, the pre-alignment metal tube and the gradual wrapping of the metal around the ferrule tip in multiple increments allow the shifting of the EVEN layers to their final positions.

15. The method of claim 9 further comprising The Right and Left Bundles are called Bundle [A] and Bundle [B]. The position of each fiber in Bundle [A] is numbered in a clockwise direction. Similarly, the position of each fiber in Bundle [B] is numbered in a counterclockwise direction relative to each other. See FIG. (6.2).

16. The method of claim 9 further comprising Device applications require one bundle and one device. The bundle and the chip are first aligned and then mounted together. As an example, a bundle can be mounted to a fiber optic splitter, MEM, or optical switch.

17. The method of claim 16 further comprising For device applications such as fiber optic splitters, a single bundle is aligned and attached to the chip

18. The method of claim 1 further comprising The concentricity correction using the center fiber to the ferrule diameter is done by using an Optical Grinding Equipment. See FIG. (5.4)

19. The method of claim 17 further comprising For device applications, the first step is to align the Curve Symmetrical Lines of the bundle and the chip. The second step is to glue the chip and the bundle together.

20. The method of claim 9 further comprising For connector applications, the first step is to align the Curve Symmetrical Lines of two bundles. Next, the adjustable key of one bundle is aligned to the fixed key of the Master Bundle. Finally, the adjustable key is glued in place.

21. The method of claim 6 further comprising Dynamically wrapping metal tip of the precision ferrule reduces the shape and volume to a minimum and guarantees alignment of each fiber in the bundle. See FIG. (5.2).
